(19) United States
(12) Patent Application Publication
(10) Pub. No.: US 2026/0173992 A1
(43) Pub. Date: Jun. 25, 2026

(54) AGRICULTURAL MACHINE COMPRISING AN OBSTACLE DETECTION DEVICE WITH GROUND CONTACT MEMBER

(71) Applicant: NAÏO-TECHNOLOGIES, ESCALQUENS (FR)

(72) Inventors: Marc ROUSSEL, PECHBONNIEU (FR); Bruno MATHIEU, CASTANET (FR); Frédéric VALLECALLE, LABARTHE SUR LÈZE (FR); Denis MOINDRAULT, MAUREMONT (FR); Gaëtan SÉVERAC, TOULOUSE (FR); Aymeric BARTHES, FLOURENS (FR)

(21) Appl. No.: 19/124,451

(22) PCT Filed: Oct. 27, 2023
(86) PCT No.: PCT/EP2023/080053

§ 371 Date: Apr. 25, 2025

(30) Foreign Application Priority Data
Oct. 28, 2022 (FR) FR2211300

(51) Int. Cl. G05D 1/00

(52) U.S. Cl. CPC A01B 69/008; A01B 63/111; G05D 1/622

(57) ABSTRACT

The invention relates to an autonomous agricultural machine including a frame and means for moving the machine intended to rest on a ground, as well as an obstacle detection device attached to said frame on one side, the obstacle detection device including a sensing edge configured to detect an obstacle in the environment of the machine by contact with said obstacle, the obstacle detection device further comprises a ground contact member, arranged on the obstacle detection device between the sensing edge and the side attached to the frame, and such that a lower end of the contact member is closer to a ground contact plane of the means for moving the machine than a lower end of the sensing edge.

### CROSS REFERENCE TO RELATED APPLICATIONS

This application is a National Stage of International Application No. PCT/EP2023/080053, having an International Filing Date of 27 Oct. 2023, which designated the United States of America, and which International Application was published under PCT Article 21(2) as WO Publication No. 2024/089238, which claims priority from and the benefit of French Patent Application No. 2211300 filed on 28 Oct. 2022, the disclosures of which are incorporated herein by reference in their entireties.

### BACKGROUND

### Field

The field of the present disclosure is that of land vehicles, in particular that of agricultural machinery, in particular autonomous machinery.

More specifically, the present disclosure relates to an agricultural machine comprising an obstacle detection device with a ground contact member.

The present disclosure can be applied in particular in the field of agriculture.

### Brief Description of Related Developments

Agricultural machinery technology is known in the prior art. These machines generally have obstacle detection devices, in order to detect obstacles in the environment of the machine, for reasons of safety and physical integrity of the machine and/or its environment.

Obstacle detection devices of the type comprising a sensing safety edge are known. Such a sensing edge can detect an obstacle by contact with it, in order in particular to stop the machine.

However, such an obstacle detection device has the risk of being triggered unintentionally, especially when the machine is traveling on compacted ground.

Such triggering is highly detrimental, as it involves checking the cause of the machine stoppage and possibly restarting it. In addition, the productivity of the machine is greatly reduced.

### SUMMARY

The present disclosure aims to overcome all or some of the aforementioned drawbacks of the prior art.

To this end, the present disclosure proposes an agricultural machine comprising a frame and means for moving the machine intended to rest on a ground, as well as an obstacle detection device attached to said frame on one side, the obstacle detection device comprising a sensing edge configured to detect an obstacle in the environment of the machine by contact with said obstacle, the obstacle detection device further comprises a ground contact member, arranged on the obstacle detection device between the sensing edge and the side attached to the frame, and such that a lower end of the contact member is closer to a ground contact plane of the means for moving the machine, i.e. the plane passing through the points or surfaces of contact of the moving means with a flat ground, than a lower end of the sensing edge.

In this way, thanks to the particular position of the contact member with respect to the sensing edge, it can be ensured that the contact member comes into contact with the ground before the sensing edge, known as the safety edge, when the machine is traveling on compacted, undulating or hilly ground.

This prevents the sensing edge from falsely detecting obstacles when the machine is at a steep incline. In this way, it is also possible to prevent the machine from stopping unexpectedly when it is controlled to stop by the sensing edge.

This greatly improves the productivity of the machine, while ensuring safe use of the machine thanks to the presence of the sensing edge.

In addition, it should be noted that the contact member is passive, i.e. purely mechanical. Thus, a very simple and inexpensive solution can be implemented.

According to one preferred aspect, the lower end of the contact member is located at a distance from the contact plane of the means for moving the machine between 50 and 300 mm.

According to one preferred aspect, the contact member comprises at least one ground contact wheel.

Such a contact member is very inexpensive and prevents any resistance from the member when the latter comes into contact with the ground.

According to one aspect, the contact member comprises two wheels, a first and a second wheel being arranged respectively substantially at a first end and a second end of the sensing safety edge.

According to an alternative, the contact member comprises at least one ground contact roller.

### BRIEF DESCRIPTION OF THE FIGURES

Other advantages, aims and specific features of the present disclosure will become apparent from the following non-limiting description of at least one particular aspect of the devices and methods that are objects of the present disclosure, with reference to the appended drawings, wherein:

FIG. 1 illustrates an autonomous agricultural machine according to the disclosure traveling on compacted ground, at three distinct moments (a), (b) and (c),

FIG. 2 is a detailed view of the obstacle detection device of the machine shown in FIG. 1,

FIG. 3 is a perspective view of the obstacle detection device shown in FIG. 2.

FIG. 4 illustrates the machine shown in FIG. 1 and the ground contact plane, as well as the distances of the sensing edge and the contact member with the ground contact plane.

### DETAILED DESCRIPTION

This description is not intended to be limiting, each feature of an aspect could advantageously be combined with any other feature of any other aspect.

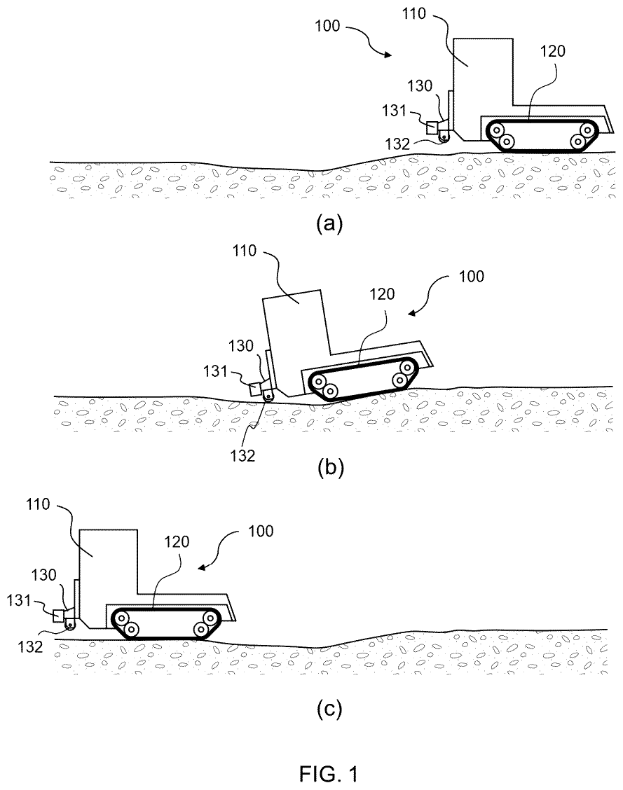

As illustrated in FIG. 1, an autonomous agricultural machine 100 comprises a frame 110 and movement means 120.

For example, the machine 100 is autonomous, i.e. it is capable of performing one or more agricultural tasks without requiring human action. M ore generally, the machine 100 may be an agricultural robot, a self-propelled agricultural vehicle or a towed agricultural vehicle, etc.

The movement means 120 are intended to rest on a ground, on which the machine 100 is traveling.

For example, the ground is a field of crops. Such a field may comprise furrows and/or mounds, in which case the ground is said to be undulating or compacted.

As can be seen in FIG. 1, at moment (a) the machine 100 is traveling on substantially horizontal ground.

At moment (b), the machine 100 encounters a furrow, and is on a downward slope in its direction of travel.

The machine 100 comprises an obstacle detection device 130. The obstacle detection device 130 is configured to detect an obstacle in the environment of the machine 100 by contact with said obstacle. To this end, the obstacle detection device 130 comprises a sensing edge 131. The sensing edge 131 is arranged in front of the machine 100, so that the sensing edge 131 first comes into contact with an obstacle standing in the path of the machine 100.

It should be noted here that the obstacle detection device 130, and therefore the sensing edge 131, can be arranged at the rear, at the front or on the sides of the machine 100, as circumstances require.

Such a sensing edge 131 is known in the art, in particular in combination with a robot control unit for commanding the stoppage of the machine upon detection of an obstacle.

The obstacle detection device 130 further comprises a ground contact member 132.

The contact member 132 is arranged such that the contact member 132 comes into contact with the ground before the sensing edge 131 when the machine 100 is traveling on compacted ground, as illustrated in FIG. 1 at moment (b).

Thus, at moment (b), the sensing edge 131 does not come into contact with the ground despite the steep slope of the ground. The sensing edge 131 then detects no obstacle, and in particular no stopping of the machine 100 is commanded. The machine 100 can continue its path, and by way of example regain a substantially horizontal ground as shown in FIG. 1 at moment (c), without any disturbance or untimely stoppage.

Of course, the obstacle detection device 130 operates in a perfectly equivalent manner when the machine 100 is traveling in an opposite direction, i.e. from moment (c) to moment (a) in FIG. 1.

The contact member 132 therefore acts as a first contact element with the ground when the machine 100 tilts. In addition, it makes it possible to slightly push the machine 100 in a direction opposite to its inclination direction, which helps to avoid triggering of the sensing edge 131.

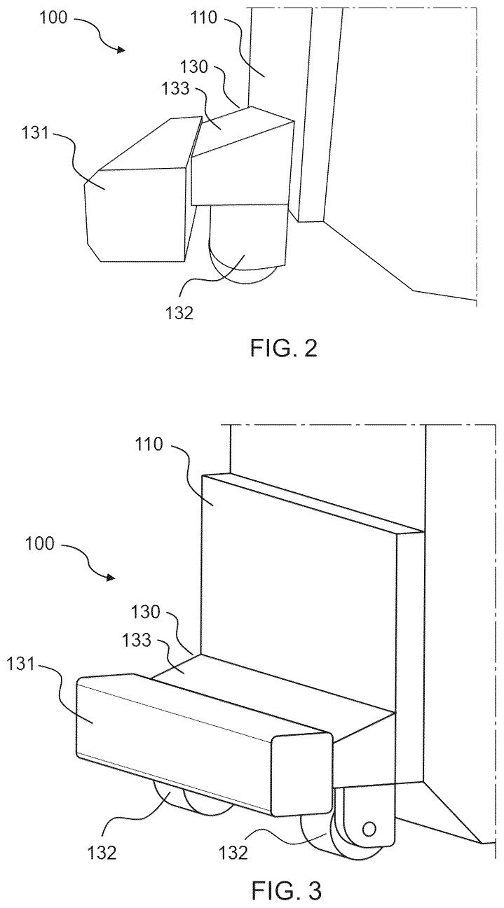

More specifically, with reference to FIGS. 2 and 3, the obstacle detection device 130 comprises a support structure 133. The support structure 133 is substantially elongated and extends substantially over the same length as the sensing edge 131, i.e. substantially over the width of the machine 100. The support structure 133 is attached to the frame 110 by a first longitudinal side.

The sensing edge 131 is attached to the support structure 133 at a second longitudinal side of the support structure 133, opposite the first longitudinal side.

The contact member 132 is attached to the support structure 133 at a third longitudinal side of the support structure 133, oriented towards the ground when the machine 100 is in use.

Thus, the contact member 132 is arranged between the sensing edge 131 and the frame 110.

In addition, the contact member 132 is thus arranged such that a lower end of the contact member 132 is closer to a ground contact plane P of the means 120 for moving the machine than a lower end of the sensing edge 131. However, the contact member 132 does not touch the ground when the machine 100 is traveling on horizontal and flat ground.

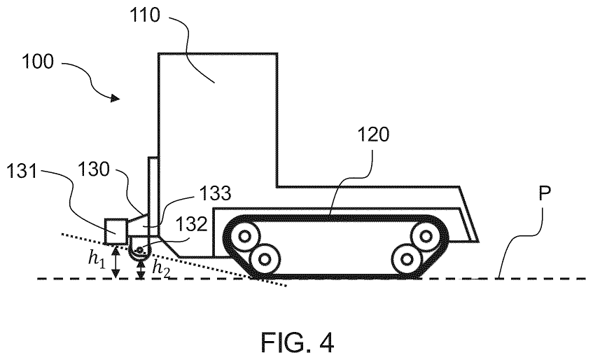

As shown in FIG. 4, the ground contact plane P of the movement means 120 is defined as the plane passing through the points or surfaces of contact of the means 120 for moving the machine 100 with a flat ground. Here, the movement means 120 are tracks, however any other type of movement means, such as wheels, may be envisaged here.

When the movement means 120 are two tracks, the ground contact plane P is defined as the plane passing through the ground contact surfaces of each of the tracks. When the movement means 120 are wheels, for example with 4 wheels, the ground contact plane P is defined as the plane passing through the contact points (or surfaces with reduced dimensions, equivalent to points) of the wheels with a flat ground.

The lower end of the sensing edge 131, i.e. the end of the sensing edge which is oriented towards the ground when the machine 100 is traveling on a ground, is located at a distance h1 from the ground contact plane P, as shown in FIG. 4. The lower end of the contact member 132, i.e. the end of the contact member 132 which is oriented towards the ground when the machine 100 is traveling on a ground, is located at a distance h2 from the ground contact plane P, as shown in FIG. 4.

The distance h2 is smaller than the distance h1.

As shown in FIG. 4, the distances h1 and h2 are measured orthogonally to the ground contact plane P.

In other words, when the machine 100 is in use with its movement means 120 which rest on the ground, the lower end of the contact member 132 is located lower on the machine 100 than the lower end of the sensing edge 131.

It should be noted here that it is not conceivable to simply fix the sensing edge 131 further away from the ground contact plane of the movement means, in order to avoid its triggering.

Indeed, in many states, local regulations require the presence of obstacle detection devices, and prescribe their position on vehicles. The position prescribed in France is a maximum of 200 to 300 mm from the ground contact plane of the movement means. Such a position does not allow a satisfactory use of a machine 100 without the presence of the contact member 132.

Thus, the lower end of the contact member 132 is preferably located substantially at a distance between 50 and 300 mm from the ground contact plane of the means for moving the machine.

It should be noted that the aforementioned distances are orthogonal to the ground contact plane of the means for moving the machine.

The distance of the lower end of the contact member 132 from the ground contact plane P will be selected as a function of the distance of the lower end of the sensing edge 131 from the ground contact plane P, and the distance of the movement means 120 from the sensing edge 131.

In FIG. 4, the line passing through the furthest point of the machine 100 at the lower end of the sensing edge 131, and through the ground contact point of a movement means 120 closest to the sensing edge 131, is shown as a dotted line. The ground contact point of a movement means 120 closest to the sensing edge 131 corresponds to a tipping point of the machine 100. In the case of movement means 120 which are tracks, this point corresponds to the point (or line) of contact with the ground proximal to the sensing edge 131. In the case of wheels as movement means 120, the point corresponds to the ground contact point of the wheel closest to the sensing edge 131.

The precise position of the contact member 132 is selected such that its lower end is located below the aforementioned line, when the machine 100 is resting on the ground, as illustrated in FIG. 4.

Preferably, the contact member 132 comprises at least one wheel. The wheel is attached to the support structure 133 by a wheel arm, such that the wheel can roll on the ground when the latter touches the ground.

The contact member 132 can comprise two wheels. A first wheel is arranged substantially at a first end of the sensing edge 131. A second wheel is arranged substantially at a second end of the sensing edge 131. Here, as previously described, the wheels of the contact member 132 are fixed to the support structure 133, which runs substantially along the sensing edge 131.

Alternatively, the contact member 132 can comprise at least one roller (not shown) in contact with the ground. Such a roller may be mounted movably, for example rotatably, or not, on the support structure 133. The roller can also take the form of a block of material, in particular of elastic material.

More generally, the disclosure is not limited to the examples described above.

What is claimed is:

1. An agricultural machine comprising a frame and means for moving the machine intended to rest on a ground, as well as an obstacle detection device attached to said frame on one side, the obstacle detection device comprising a sensing edge configured to detect an obstacle in the environment of the machine by contact with said obstacle, characterized in that the obstacle detection device further comprises a ground contact member, arranged on the obstacle detection device between the sensing edge and the side attached to the frame, and such that a lower end of the contact member is closer to a ground contact plane of the means for moving the machine, i.e. the plane passing through the points or surfaces of contact of the moving means with a flat ground, than a lower end of the sensing edge.

2. The machine according to claim 1, wherein the lower end of the contact member is located at a distance from the ground contact plane of the means for moving the machine between 50 and 300 mm.

3. The machine according to claim 1, wherein the contact member comprises at least one ground contact wheel.

4. The machine according to claim 3, comprising two wheels, a first and a second wheel being arranged respectively substantially at a first end and a second end of the sensing edge.

5. The machine according to claim 1, wherein the contact member comprises at least one ground contact roller.
